(19) United States
(12) Patent Application Publication
(10) Pub. No.: US 2022/0275007 A1
(43) Pub. Date: Sep. 1, 2022

(54) FLOW REACTION PROCESS FOR MANUFACTURE OF BORON-CONTAINING AGROCHEMICALS

(71) Applicant: BORAGEN, INC., Durham, NC (US)

(72) Inventors: Chunliang LIU, Cary, NC (US); Yong-Kang ZHANG, San Jose, CA (US); Chun Yu LIU, Durham, NC (US); Marissa Caroline AUBREY, Durham, NC (US)

(21) Appl. No.: 17/631,741

(22) PCT Filed: Jul. 29, 2020
(86) PCT No.: PCT/US20/44071

§ 371 Date: Jan. 31, 2022

Related U.S. Application Data
(60) Provisional application No. 62/880,432, filed on Jul. 30, 2019.

(51) Int. Cl. C07F 5/04; C07F 5/02; A01N 59/04

(52) U.S. Cl. CPC C07F 5/04; C07F 5/025; A01N 59/04

(57) ABSTRACT

The present invention relates to methods of preparing benzoxaboroles. Benzoxaborole compounds have shown promise as antimicrobial agents, especially against fungal pathogens. The invention also relates to compositions of acyclic alkoxy boronic acid esters as intermediates, and continuous flow processes of mixing the intermediates with organomagnesium, magnesium, or organolithium reagents to form the desired benzoxaboroles.

### CROSS-REFERENCE TO RELATED APPLICATIONS

The present application claims priority to U.S. Provisional Application Ser. No. 62/880,432 filed 30 Jul. 2019, herein incorporated by reference in its entirety.

### TECHNICAL FIELD

The present invention relates to methods for the preparation of benzoxaboroles. More particularly, the present invention relates to a continuously flowing process for preparation of benzoxaboroles.

### BACKGROUND

Benzoxaborole compounds have been developed into commercially viable human therapeutics such as CRISABOROLE and TAVABOROLE. Processes to synthesize benzoxaborole compounds have sometimes relied on transition metal catalyzed C—X and C—H borylation; it would be advantageous to prepare benzoxaborole compounds in more cost- and material-efficient methods. Other known processes have low yield of benzoxaborole compounds, and often start with expensive compounds and reagents. Moreover, while the Sandmeyer reaction is a key step for the synthesis of benzoxaboroles, this halogenation of anilines has been limited by the narrow substrate scope of starting reagents and energy consuming conversion of intermediates.

A method that is increasing in popularity within the pharmaceutical industry is continuous flow chemistry. Continuous flow chemistry differs from the more traditional batch chemistry in that the chemical reaction is performed in a pipe or a tube rather than a stirred vessel. Use of continuous flow chemistry has several benefits and advantages. For example, reactions that are conducted in a continuous flow format are safer because, amongst other reasons, the format allows for better temperature control and lower reaction volumes. Additionally, flow chemistry reactions are also generally faster and allow for access to reactions that are challenging to accomplish in a batch format. Flow chemistry is additionally advantageous in that it is quicker to scale up from proof of concept studies to large-scale manufacturing. See, for example, Baumann et al., A Perspective on Continuous Flow Chemistry in the Pharmaceutical Industry, Org. Process Res. Dev., 2020, https://doi.org/10.1021/acs.oprd.9b00524.

While flow chemistry offers many advantages, such as those outlined above, it still has drawbacks. For example, this format is still relatively young compared to batch chemistry techniques, and while the number of continuous flow publications have been increasing over the past decade the vast majority of those publications come from academics. Additionally, the development of flow chemistry processes in industry is often hindered because of project deadlines that do not allow chemists to re-design or even consider converting a given chemical process from batch into flow concepts. Transitioning from a batch process to a flow process requires an analysis to determine if the switch would even provide any advantages, such as costs savings, or if the reaction is even amenable to being done in a continuously flowing process. Baumann et al., A Perspective on Continuous Flow Chemistry in the Pharmaceutical Industry, Org. Process Res. Dev., 2020, https://doi.org/10.1021/acs.oprd.9b00524.

There is a need for processes that minimize the number of overall steps to create the intended benzoxaboroles. Also, there is a need for intermediates that reduce the number of steps required to synthesize the intended compound in significantly reduced cost. Accordingly, there is a need for new processes for the creation of benzoxaboroles that are simple, efficient, and cost-effective.

### SUMMARY

The present disclosure relates to methods of preparing benzoxaboroles. The methods disclosed herein employ novel boron-containing chemistries to deliver an elegant and cost-effective process for the synthesis of benzoxaboroles.

One embodiment of the present disclosure includes a continuously flowing process comprising, mixing a compound of formula (I)

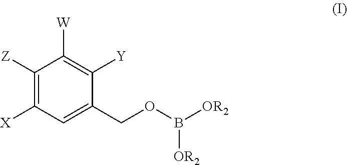

with an organomagnesium, magnesium, or an organolithium reagent to produce a compound of formula (II) or an agriculturally or pharmaceutically acceptable salt thereof:

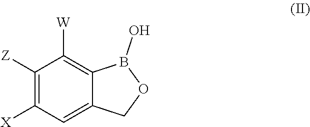

wherein:
X is hydrogen, fluorine, chlorine, bromine, or

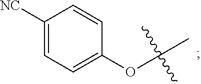 [SMILES: *Oc1ccc(C#N)cc1]

Z and W is each independently hydrogen, or OR³ wherein R³ is a C₁-C₅ hydrocarbyl;
Y is bromine or iodine; and
R² is selected from the group consisting of: isopropyl, methyl, ethyl, n-propyl, sec-butyl, tert-butyl, and n-butyl, or two R² groups taken together with boron atom form a ring.
In one aspect, the compound of formula (I) is compound of formula (Ia)

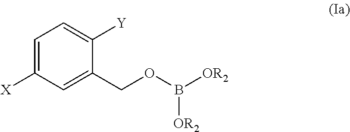

and the compound of formula (II) produced is formula (IIa):

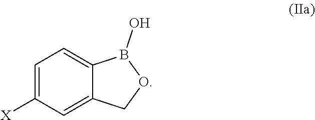

In one aspect, X is chlorine and Y is bromine.

In one aspect, the organomagnesium or organolithium reagent is isopropyl magnesium chloride, isopropylmagnesium chloride lithium chloride complex, n-butyllithium, sec-butyllithium, or tert-butyllithium. In one aspect, the magnesium reagent further comprises an initiator.

In one embodiment, the continuously flowing further comprises a step of slurrying the compound of formula (II) in a hydrocarbon solvent. In one aspect, the hydrocarbon solvent is pentane, hexane, heptane, C₅-C₁₀ hydrocarbon mixtures, or any combination thereof.

In one embodiment, the continuously flowing process further comprises preparing the compound of formula (I) by mixing a compound of formula (III):

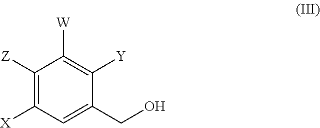

with a boron containing reagent selected from the group consisting of trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, 2-ethoxy-4,4,5,5-tetramethyl-1,3,2-dioxaborolane, and a compound of formula (IV):

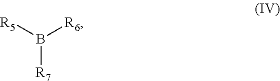

wherein each of R⁵, R⁶, and R⁷ is independently OR* or H wherein R* is C₁-C₇ alkyl, or wherein any two R* of R⁵, R⁶, and R⁷ are taken together form a ring; and
removing at least a portion of an alcohol by-product.

In one aspect, the continuously flowing process further comprises dissolving the compound of formula (III) in a solvent, wherein the solvent is toluene, xylene, benzene, chloroform, 1,4-dioxane, tert-butyl methyl ether, 2-methyltetrahydrofuran or tetrahydrofuran.

In one aspect, the continuously flowing process further comprises increasing temperature such that a vapor of the solvent or a solvent and alcohol by-product mixture reduces the alcohol by-product by about 50%-99.9%, and keeping the temperature constant until such reduction is achieved. In one aspect, the solvent is reduced by about 65%-75%. In one aspect, the solvent is toluene or THF and the boron containing reagent is tri-isopropyl borate. In one aspect, the continuously flowing process further comprises removing at least 75% of the toluene or THF.

In one aspect, the continuously flowing process further comprises mixing an aqueous Bronsted acid to produce the compound of formula (II). In one aspect, the continuously flowing process further comprises crystallizing the compound of formula (II) in presence of at least one organic solvent. In one aspect, the aqueous Bronsted acid comprises hydrobromic acid, phosphinic acid, hydrochloric acid, sulphuric acid, tetrafluoroboric acid, acetic acid, trifluoroacetic acid, methanesulfonic acid, or salicylic acid. In one aspect, the at least one organic solvent is isopropyl acetate and ethyl acetate and the acid is hydrochloric acid.

One embodiment of the present disclosure includes the continuously flowing process of the present disclosure further comprising preparing the compound of formula (III) by mixing a compound of formula (V):

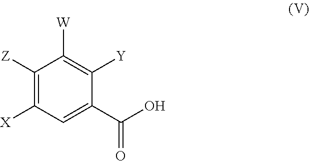

with a reducing agent, wherein each of X, Y, Z, and W is as defined.

In one aspect, the reducing agent is a borane complex, borane-tetrahydrofuran, borane-dimethylsulfide, lithium aluminum hydride, or sodium borohydride. In one aspect, the continuously flowing process further comprises preparing the compound of formula (V) by mixing a compound of formula (VI):

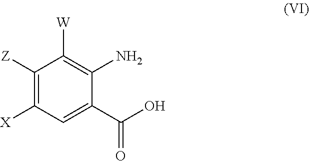

with a nitrite source, an acid, a catalyst, and a halide source.

In one aspect, the nitrite source is an alkyl nitrite, t-butyl nitrite, ethyl nitrite, amyl nitrite, polyethylene glycol nitrite, sodium nitrite, potassium nitrite, or cesium nitrite; the halide source is Br₂, TMSBr, hydrobromic acid, iodine (12), TMSI, hydroiodic acid, iodine monochloride, mixtures of free iodine and free chloride, alkali iodides, alkali halides, metal halides, inorganic iodides, or transition metal halides; and the catalyst is a copper catalyst, a cuprous ion, or a cupric ion.

In one aspect, the reducing agent is borane-dimethylsulfide, and the boron containing reagent is tri-isopropyl borate.

In one embodiment the continuously flowing process further comprises mixing the compound of formula (II) with HCl solution, and slurrying the compound of formula (II) in heptane prior to crystallizing. In one aspect, wherein the organolithium reagent is n-BuLi; the compound of formula (I) is mixed with the organolithium reagent at a temperature between −40° C. and 10° C.; and the compound of formula (II) is formed in a continuous flow process.

In one embodiment, the mixing of a compound of formula (I) and the organomagnesium, magnesium, or organolithium reagent produces a lithiation stream under a first set of parameters and a second set of parameters effects a borylation stream to produce the compound of formula (II).

One embodiment of the present disclosure includes a one pot process of including the steps of:
a) mixing a compound of formula (IIIa):

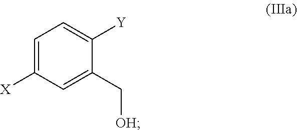

with a boron containing reagent to form a compound of formula (Ia):

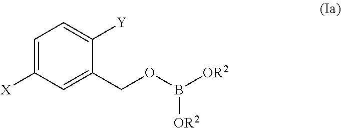

b) mixing the compound of formula (Ia) with n-BuLi at a temperature between about −40° C. and 10° C. to form the compound of formula (IIa) or an agriculturally or pharmaceutically acceptable salt thereof:

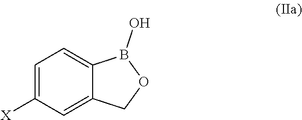

where:
R² is selected from the group consisting of isopropyl, methyl, ethyl, n-propyl, sec-butyl, tell-butyl, and n-butyl, or two R² groups taken together with the boron atom form a ring;
X is chlorine; and
Y is bromine.

One embodiment of the present disclosure includes a process comprising:

mixing a compound of formula (I):

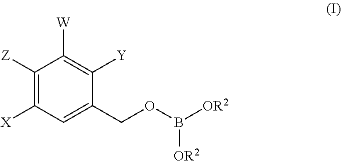

with an organomagnesium, magnesium, or an organolithium reagent to produce a compound of formula (II) or an agriculturally or pharmaceutically acceptable salt thereof:

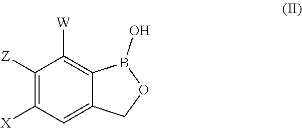

where:
X is hydrogen, fluorine, chlorine, bromine, or

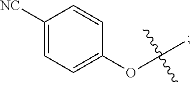

Z and W is each independently hydrogen, or OR³ where R³ is a C₁-C₅ hydrocarbyl;
Y is bromine or iodine; and
R² is selected from the group consisting of: isopropyl, methyl, ethyl, n-propyl, sec-butyl, tell-butyl, and n-butyl, or two R² groups taken together with the boron atom form a ring.

One embodiment of the present disclosure includes a continuously flowing process comprising:

mixing a compound of formula (X)

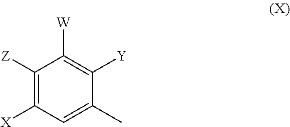

with an organomagnesium, magnesium, or an organolithium reagent and a boron containing reagent to produce a compound of formula (XI)

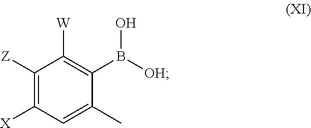

treating a compound of formula (XI) to an iron-catalyzed oxidation to form an aldehyde derivative of formula (XII):

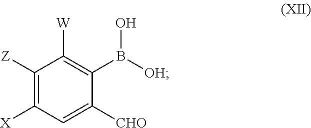

treating a compound of formula (XII) with a reducing agent to form a compound of formula (II) or an agriculturally or pharmaceutically acceptable salt thereof:

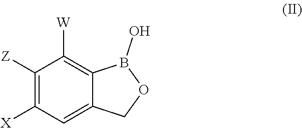

where:
X is hydrogen, fluorine, chlorine, bromine, or

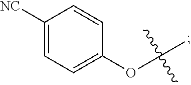

Z and W is each independently hydrogen, or OR³ where R³ is a C₁-C₅ hydrocarbyl; and
Y is bromine or iodine.

In one aspect, Z and W are hydrogen. In one aspect, the boron containing reagent is a trialkyl borate and the reducing agent is NaBH₄ or BH₃.

One embodiment of the present disclosure includes novel intermediates. One embodiment of the present disclosure includes a compound of formula (I):

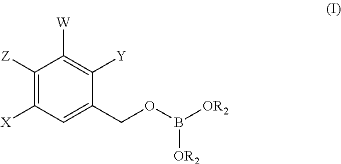

wherein:
X is hydrogen, fluorine, chlorine, bromine, or

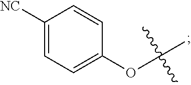

Z and W is each independently hydrogen, or OR₃ wherein R₃ is a C₁-C₅ hydrocarbyl;
Y is bromine or iodine; and
R² is selected from the group consisting of: isopropyl, methyl, ethyl, n-propyl, sec-butyl, tell-butyl, and n-butyl, or two R² groups taken together with the boron atom to form a ring.

One embodiment of the present disclosure includes a compound of formula (Ia):

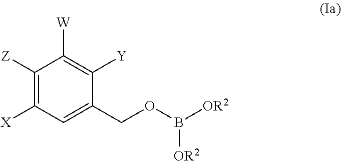

wherein:
X is hydrogen, fluorine, chlorine, bromine, or

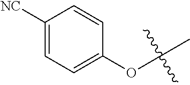 [SMILES: *Oc1ccc(C#N)cc1]

Z and W is each independently hydrogen, or OR³ where R³ is a C₁-C₅ hydrocarbyl;
Y is bromine or iodine; and
R² is selected from the group consisting of: isopropyl, methyl, ethyl, n-propyl, sec-butyl, tert-butyl, and n-butyl, or two R² groups taken together with the boron atom form a ring.

One embodiment of the present disclosure includes a compound of formula (Ia):

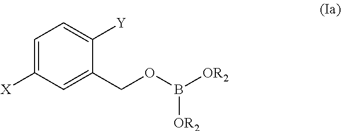

wherein X is chlorine; Y is bromine; and R² is isopropyl.

### DETAILED DESCRIPTION

In certain instances, the description includes specific details for the purpose of providing an understanding of the described subject matter. However, it will be apparent to those skilled in the art that embodiments may be practiced without the specific details as described.

Any reference in the specification to “one embodiment” or “an embodiment” or “another embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

In one aspect of the present disclosure is a process that includes mixing a compound of formula (I):

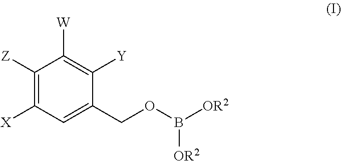

with an organomagnesium, magnesium or an organolithium reagent to produce a compound of formula (II) or an agriculturally or pharmaceutically acceptable salt thereof:

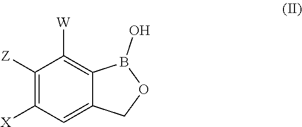

where X is hydrogen, fluorine, chlorine, bromine or

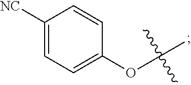

Z and W is each independently hydrogen or OR³ where R³ is a C₁-C₅ hydrocarbyl;
Y is either bromine or iodine, and
R² is selected from the group consisting of isopropyl, methyl, ethyl, n-propyl, sec-butyl, tell-butyl, and n-butyl, or two R² groups taken together with the boron atom form a ring,
wherein the compound of formula (I) and the organomagnesium, magnesium, or organolithium reagent are mixed in a continuously flowing manner.

In one embodiment of the process of the present disclosure, the compound of formula (I) described herein is formula (Ia):

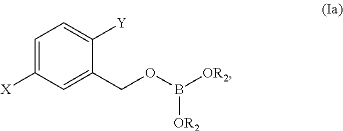

and the compound of formula (II) produced is formula (IIa):

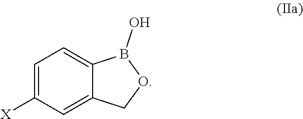

In another embodiment, the two R² groups taken together with the boron atom with which they form a ring, can either form an 4-8 membered ring, or a 5-7 membered ring. In yet another embodiment, the organolithium reagents of the present disclosure are selected from the group consisting of isopropyl magnesium chloride, isopropyl magnesium chloride-lithium chloride complex, n-butyl lithium, sec-butyl lithium, and tert-butyl lithium. In a further embodiment, the compounds of formula (I) are mixed with a magnesium reagent that further comprises an initiator.

In one embodiment, the compounds of formula (I) are mixed with a magnesium reagent at a temperature between about 10° C. and 80° C. In yet another embodiment, the present disclosure is a continuously flowing process where the compound of formula (I) is mixed with magnesium at a temperature between about 15° C. and 80° C. to form the compound of formula (II).

In one embodiment, the process of the present disclosure further includes slurrying the compound of formula (II) in a hydrocarbon solvent, such as pentanes, hexanes, heptanes or C₅-C₁₀ hydrocarbon mixtures, or any combinations thereof. In yet one embodiment, the hydrocarbon solvent of the present disclosure is heptane.

In yet another embodiment, the present disclosure further includes preparing the compound of formula (I) by mixing a compound of formula (III):

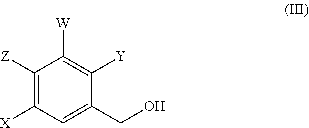

with a boron containing reagent selected from the group consisting of trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, and 2-ethoxy-4,4,5,5-tetramethyl-1,3,2-dioxaborolane, or a compound of formula (IV):

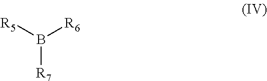

where, each of R⁵, R⁶, and R⁷ is independently OR* or H, where R* is C₁-C₇ alkyl, and where any two R* of R⁵, R⁶, and R⁷ taken together form a ring; where
X is hydrogen, fluorine, chlorine, bromine or

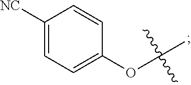

Z and W is each independently hydrogen or OR³ where R³ is a C₁-C₅ hydrocarbyl; and
Y is either bromine or iodine.

In another embodiment of the process of the present disclosure, the compound of formula (III) described herein is a compound of formula (IIIa):

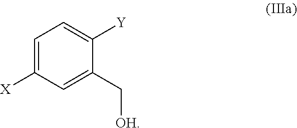

In a further embodiment, the present disclosure further includes dissolving the compound of formula (III) in a solvent, where the solvent is selected from the group consisting of toluene, xylene, CHCl₃, tetrahydrofuran, 2-methyltetrahydrofuran, benzene, 1,4-dioxane, and tert-butyl methyl ether.

In one embodiment, the conversion of a compound of formula (I) to a compound of formula (II) further comprises a work up step under acidic conditions using an aqueous Bronsted acid to produce the compound of formula (II). In yet another embodiment, the present disclosure comprises crystallizing the compound of formula (II) from at least one organic solvent. In a still further embodiment, the present disclosure includes work up with an aqueous Bronsted acid to produce the compound of formula (II) and still further includes crystallizing the compound of formula (II) from at least one organic solvent. In a still further embodiment, the present disclosure further includes work up with an aqueous Bronsted acid to produce the compound of formula (IIa) and crystallizing the compound of formula (IIa) from at least one organic solvent. In some embodiments, the Bronsted acid is selected from a group consisting of hydrobromic acid, phosphinic acid, hydrochloric acid, sulphuric acid, tetrafluoroboric acid, acetic acid, trifluoroacetic acid, methanesulfonic acid, and salicylic acid. In one embodiment, the at least one organic solvent is a mixture of isopropyl acetate and ethyl acetate.

In still another embodiment, the present disclosure further includes work up with an aqueous Bronsted acid such as HCl to produce the compound of formula (II) and crystallizing the compound of formula (II) from a mixture of isopropyl acetate and ethyl acetate. In yet another embodiment of the present disclosure formula (II) is represented by the compound of formula (IIa), and the present disclosure includes work up with an aqueous Bronsted acid such as HCl to produce the compound of formula (IIa) and crystallizing the compound of formula (IIa) from a mixture of isopropyl acetate and ethyl acetate.

In one embodiment, the present disclosure further includes preparing the compound of formula (III) by mixing a compound of formula (V):

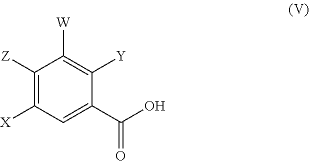

with a reducing agent. In yet another embodiment, the reducing agent of the present disclosure is selected from the group consisting of a borane complex, borane-tetrahydrofuran, borane-dimethylsulfide, lithium aluminum hydride, and sodium borohydride. In some embodiments, the carboxylic acid is first converted to an acyl halide. Exemplary reagents to achieve this transformation include: SOCl₂, PCl₃, PCl₅, cyanuric fluoride, and cyanuric chloride. The acyl halide can then be reduced to the compound of formula (III) with the reducing agent as described herein.

In another embodiment, the present disclosure further includes preparing the compound of formula (IIIa) by mixing a compound of formula (Va):

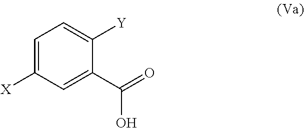

with a reducing agent. In yet another embodiment, the reducing agent of the present disclosure is selected from the group consisting of a borane complex, borane-tetrahydrofuran, borane-dimethylsulfide, lithium aluminum hydride, and sodium borohydride. In some embodiments, the carboxylic acid is first converted to an acyl halide. Exemplary reagents to achieve this transformation include: SOCl₂, PCl₃, PCl₅, cyanuric fluoride, and cyanuricchloride.

The acyl halide can then be reduced to the compound of formula (IIIa) with the reducing agent as described herein.

In one embodiment, the present disclosure further includes preparing the compound of formula (V) by mixing a compound of formula (VI):

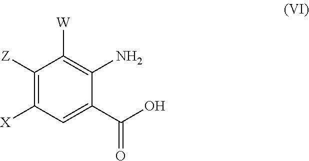

with a nitrite source, an acid, a catalyst, and a halide source. In some embodiments, the nitrite source is sodium nitrite, the acid is hydrobromic acid or sulfuric acid, the catalyst is copper bromide, and the halide source is copper bromide. In some embodiments, the preparation further comprises a solvent. In some embodiments, the solvent is a mixture of a protic solvent and a Bronstead acid. For example, the solvent may be a mixture of H₂SO₄ and water.

In another embodiment of the process of the present disclosure, the compound of formula

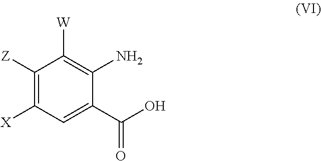

described herein is formula (VIa):

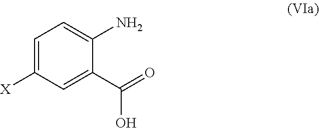

In some embodiments of the present disclosure, the nitrite source is an organic nitrite, an inorganic nitrite, an alkyl nitrite, t-butyl nitrite, ethyl nitrite, amyl nitrite, polyethylene glycol nitrite, sodium nitrite, potassium nitrite, and cesium nitrite; and the halide source is Br₂, TMSBr, hydrobromic acid, iodine (12), TMSI, hydroiodic acid, iodine monochloride, mixtures of free iodine and free chloride, alkali iodides, alkali halides such as sodium bromide or potassium bromide, earth alkali bromides such as magnesium bromide or calcium bromide, metal halides, inorganic iodides, or transition metal halides such as cuprous bromide; and the catalyst is a copper catalyst, a copper⁻¹ ion, or a copper⁻² ion.

In other embodiments, the catalyst is a copper catalyst and the copper catalyst is prepared by mixing a copper catalyst precursor with a reducing agent such as ascorbate. In one embodiment, the nitrite source and acid are mixed prior to mixing with catalyst and halide source. In some embodiments, the copper catalyst is also the halide source. In other embodiments, the copper catalyst is selected from the group consisting of: CuSO₄, CuBr and copper.

In one aspect, the present disclosure includes the steps of:

mixing a compound of formula (VIa):

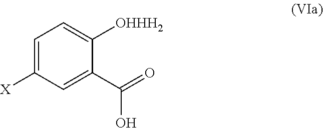

with a nitrite source, an acid, a catalyst, and a halide source, to prepare a compound of formula (Va):

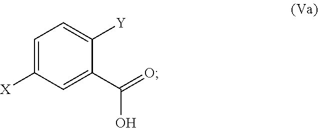

mixing the compound of formula (Va) with a reducing agent to form a compound of formula (IIIa):

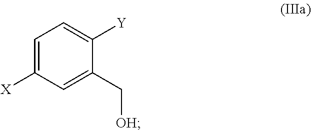

mixing the compound of formula (IIIa) with a boron containing reagent to form a compound of formula (Ia):

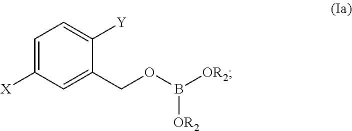

and mixing the compound of formula (Ia) and n-BuLi in a continuously flowing process at a temperature between about −40° C. to 10° C. to form a compound of formula (IIa) or an agriculturally or pharmaceutically acceptable salt thereof:

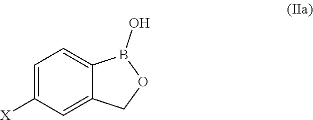

where, R² is selected from the group consisting of isopropyl, methyl, ethyl, n-propyl, sec-butyl, tert-butyl, and n-butyl, or two R² groups taken together with the boron atom form a ring; X is chlorine; and Y is bromine.

In one embodiment of the present process to prepare formula (VI or VIa), the nitrite source is selected from the group consisting of alkyl nitrite, t-butyl nitrite, ethyl nitrite, amyl nitrite, polyethylene glycol nitrite, sodium nitrite, potassium nitrite, and caesium nitrite; the halide source is selected from the group consisting of Br₂, TMSBr, hydrobromic acid, iodine (I₂), TMSI, hydroiodic acid, iodine monochloride, mixtures of free iodine and free chloride, alkali iodides, alkali halides, metal halides, inorganic iodides, and transition metal halides; the catalyst is a copper catalyst, a cuprous ion, or a cupric ion; the reducing agent is selected from the group consisting of a borane complex, borane-tetrahydrofuran, borane-dimethylsulfide, lithium aluminum hydride, or sodium borohydride; and the boron containing reagent is selected from the group consisting of trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, and 2-ethoxy-4,4,5,5-tetramethyl-1,3,2-dioxaborolane, and a compound of formula (IV):

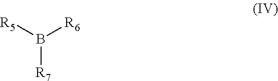

where each of R⁵, R⁶, and R⁷ is independently OR* or H, where R* is C₁-C₇ alkyl, and
where any two R* of R⁵, R⁶, and R⁷ taken together form a ring.

In one embodiment, the reducing agent is borane-dimethylsulfide, and the boron containing reagent is tri-isopropyl borate.

In yet another embodiment, the present disclosure further includes dissolving the compound of formula (IIIa) in a solvent with the boron containing reagent where the solvent is selected from the group consisting of toluene, xylene, benzene, chloroform, dichloromethane, 1,4-dioxane, tert-butyl methyl ether, or tetrahydrofuran; and removing at least a portion of the solvent to produce the compound of formula (Ia).

In yet another embodiment, the conversion of (I) to (II) further includes working up the reaction with aqueous HCl, and slurrying the compound of formula (IIa) in heptane. In still another embodiment, the present disclosure further includes crystallizing the compound of formula (IIa) in the presence of ethyl acetate and isopropyl acetate.

In one aspect, the present disclosure is a continuously flowing process that includes mixing a compound of formula (I):

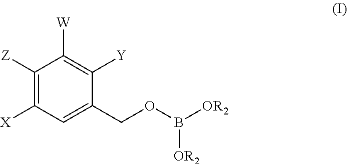

with an organomagnesium, magnesium or an organolithium reagent to form a compound of formula (II) or an agriculturally or pharmaceutically acceptable salt thereof:

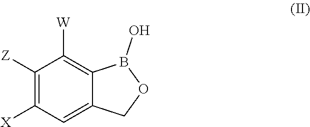

where, X is hydrogen, fluorine, chlorine, bromine or

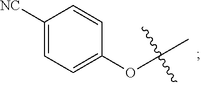 [SMILES: *Oc1ccc(C#N)cc1]

and
Z and W is each independently hydrogen or OR³ where R³ is a C₁-C₅ hydrocarbyl; Y is either bromine or iodine, and
R² is selected from the group consisting of isopropyl, methyl, ethyl, n-propyl, sec-butyl, tell-butyl, and n-butyl, or two R² groups taken together with the boron atom form a ring.

In another embodiment of the continuously flowing process of the present disclosure, the compound of formula (I) described herein is formula (Ia):

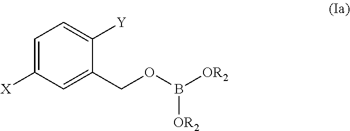

and the compound of formula (II) produced is formula (IIa):

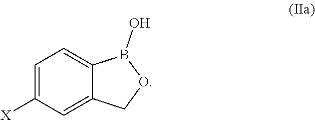

In yet another embodiment, the organomagnesium or organolithium reagents of the continuously flowing process of the present disclosure are selected from the group consisting of isopropyl magnesium chloride, isopropylmagnesium chloride lithium chloride complex, n-butyllithium, sec-butyllithium, or tert-butyllithium. In one embodiment, the organolithium reagent of the continuously flowing process is n-BuLi.

In yet another embodiment of the continuously flowing process, the compound of formula (I) is mixed with n-BuLi at a temperature between about −40° C. and 10° C. to form the compound of formula (II). In yet another embodiment of the continuously flowing process, the compound of formula (I) is mixed with n-BuLi at a temperature between about −20° C. and −15° C. to form the compound of formula (II). In one embodiment, the continuously flowing process includes mixing a compound of formula (I) with magnesium at a temperature between 10° C. and 80° C. In still a further embodiment, the compound of formula (I) is mixed with a magnesium reagent that comprises an initiator.

In one embodiment, the present disclosure is a continuously flowing process that further includes slurrying the compound of formula (II) in a hydrocarbon solvent, such as pentanes, hexanes, heptanes or C₅-C₁₀ hydrocarbon mixtures, or any combination thereof. In yet one embodiment, the hydrocarbon solvent of the present disclosure is heptane.

In yet another embodiment, the continuously flowing process of the present disclosure further includes preparing the compound of formula (I) by mixing a compound of formula (III):

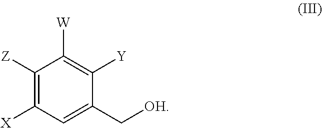

with a boron containing reagent selected from the group consisting of trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, and 2-ethoxy-4,4,5,5-tetramethyl-1,3,2-dioxaborolane, and a compound of formula (IV):

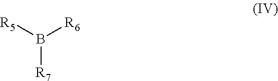

where, each of R⁵, R⁶, and R⁷ is independently OR* or H, where R* is C₁-C₇ alkyl, and where any two R* of R⁵, R⁶, and R⁷ taken together form a ring;
X is hydrogen, fluorine, chlorine, bromine or

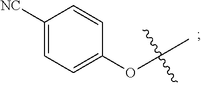 [SMILES: *Oc1ccc(C#N)cc1]

Z and W is each independently hydrogen or OR³ where R³ is a C₁-C₅ hydrocarbyl;
Y is either bromine or iodine; and
removing at least a portion of an alcohol by-product.

In another embodiment of the continuously flowing process of the present disclosure, the compound of formula (III) described herein is a compound of formula (IIIa):

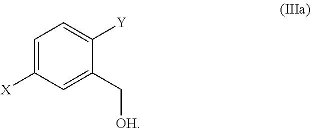

In a further embodiment, the continuously flowing process of the present disclosure further includes dissolving the compound of formula (III) in a solvent, where the solvent is selected from the group consisting of toluene, xylene, CHCl₃, tetrahydrofuran, 2-methyltetrahydrofuran, benzene, 1,4-dioxane or tert-butyl methyl ether.

In one embodiment, the continuously flowing process of the present disclosure further includes the conversion of a compound of formula (I) to a compound of formula (II) further comprises a work up step under acidic conditions using an aqueous Bronsted acid to produce the compound of formula (II). In yet another embodiment, the present disclosure comprises crystallizing the compound of formula (II) from at least one organic solvent. In a still further embodiment, the present disclosure includes work up with an aqueous Bronsted acid to produce the compound of formula (II) and still further includes crystallizing the compound of formula (II) from at least one organic solvent. In a still further embodiment, the present disclosure further includes work up with an aqeuous Bronsted acid to produce the compound of formula (IIa) and crystallizing the compound of formula (IIa) from at least one organic solvent. In some embodiments, the Bronsted acid is selected from a group consisting of hydrobromic acid, phosphinic acid, hydrochloric acid, sulphuric acid, tetrafluoroboric acid, acetic acid, trifluoroacetic acid, methanesulfonic acid, and salicylic acid. In one embodiment, the at least one organic solvent is a mixture of isopropyl acetate and ethyl acetate.

In still another embodiment, the present disclosure further includes work up with an aqueous Bronsted acid such as HCl to produce the compound of formula (II) and and crystallizing the compound of formula (II) from a mixture of isopropyl acetate and ethyl acetate. In yet another embodiment of the present disclosure formula (II) is represented by the compound of formula (IIa), and the present disclosure includes work up with an aqueous Bronsted acid such as HCl to produce the compound of formula (IIa) and crystallizing the compound of formula (IIa) from a mixture of isopropyl acetate and ethyl acetate.

In one embodiment, the continuously flowing process of the present disclosure further includes preparing the compound of formula (III) by mixing a compound of formula (V):

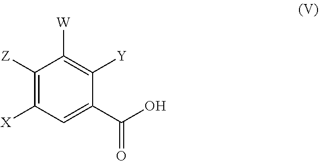

with a reducing agent. In one embodiment, the reducing agent of the present disclosure is selected from the group consisting of a borane complex, borane-tetrahydrofuran, borane-dimethylsulfide, lithium aluminum hydride, and sodium borohydride. In other embodiments, the carboxylic acid is first converted to an acyl halide. Exemplary reagents to achieve this transformation include: SOCl₂, PCl₃, PCl₃, cyanuric fluoride, and cyanuric chloride. The acyl halide can then be reduced to the compound of formula (III) with the reducing agent.

In another embodiment, the continuously flowing process of the present disclosure further includes preparing the compound of formula (IIIa) by mixing a compound of formula (Va):

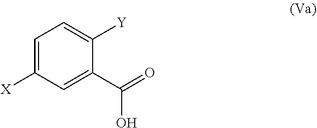

with a reducing agent. In one embodiment, the reducing agent of the present disclosure is selected from the group consisting of a borane complex, borane-tetrahydrofuran, borane-dimethylsulfide, lithium aluminum hydride, and sodium borohydride. In other embodiments, the carboxylic acid is first converted to an acyl halide. Exemplary reagents to achieve this transformation include: SOCl₂, PCl₃, PCl₃, cyanuric fluoride, and cyanuric chloride. The acyl halide can then be reduced to the compound of formula (III) with the reducing agent.

In yet another embodiment, the reducing agent of the present disclosure is selected from the group consisting of a borane complex, borane-tetrahydrofuran, borane-dimethylsulfide, lithium aluminum hydride, and sodium borohydride. In still another embodiment, the reducing agent is borane-dimethylsulfide, and the boron-containing reagent is tri-isopropyl borate.

In yet another embodiment, the continuously flowing process of the present disclosure further includes preparing the compound of formula (V) by mixing a compound of formula (VI):

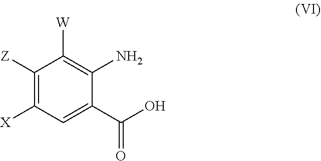

with a nitrite source, an acid, a catalyst, and a halide source.

In one embodiment of the continuously flowing process, the compound of formula (VI) described herein is formula (VIa):

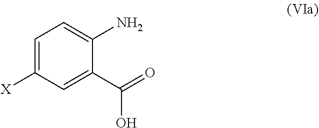

In some embodiments, the nitrite source is an organic nitrite. In other embodiments, the nitrite source is an inorganic nitrite. In yet another embodiment, the nitrite source of the present disclosure is selected from the group consisting of an alkyl nitrite, t-butyl nitrite, ethyl nitrite, amyl nitrite, polyethylene glycol nitrite, sodium nitrite, potassium nitrite, and cesium nitrite; the halide source is Br₂, TMSBr, hydrobromic acid, iodine (I₂), TMSI, hydroiodic acid, iodine monochloride, mixtures of free iodine and free chloride, alkali iodides, alkali halides, metal halides, inorganic iodides, or transition metal halides; and the catalyst is a copper catalyst, a cuprous ion, or a cupric ion.

In one aspect of the several embodiments, X is chlorine.

As used herein the term “halogen”, unless otherwise stated, is a fluorine, chlorine, bromine, or iodine.

The term “hydrocarbon”, used herein refers to paraffinic and naphthenic compounds, or any mixtures of paraffin, naphthenic, or paraffin and naphthenic compounds. Paraffinic compounds may either be linear (n-paraffins) or branched (i-paraffins). Examples of linear paraffins are pentane, hexane, heptane etc. Examples of branched paraffins are isooctane, isobutane, isopentane etc. Naphthenic compounds are cyclic saturated hydrocarbons, i.e. cycloparaffins. Such hydrocarbons with cyclic structure are typically derived from cyclopentane or cyclohexane. A naphthenic compound may comprise a single ring structure (mononaphthene) or two isolated ring structures (isolated dinaphthene), or two fused ring structures (fused dinaphthene) or three or more fused ring structures (polycyclic naphthenes or polynaphthenes).

The term “hydrocarbon solvent” refers to one or more hydrocarbons which have solvency for mineral oil. Typically, the hydrocarbon solvent comprises at least one of normal or branched chain paraffins or olefins, cyclic hydrocarbons and aromatic hydrocarbons. Often, the hydrocarbon solvent is comprised of at least 50 wt. %, preferably at least 75 wt. % and most preferably at least 90 wt. % of normal or branched chain paraffins or olefins based on the weight of the hydrocarbon solvent. In some embodiments, the hydrocarbon solvent is selected from the group consisting of isoparaffins and normal paraffins. In other embodiments, the hydrocarbon solvent is a normal paraffin. In still other embodiments, the hydrocarbon solvent comprises from 5 to 15 carbon atoms per molecule. In other embodiments, the hydrocarbon solvent comprises 7 to 10 carbon atoms per molecule. In addition, the hydrocarbon solvent does not require the presence of functional groups such as, for example, esters, alcohols, or acids. In yet other embodiments, that the hydrocarbon solvent contains less than about 5 wt. % and more preferably less than about 1 wt. % of oxygen-containing functional groups such as, for examples, esters, alcohols, acids, or mixtures thereof, based on the weight of the hydrocarbon solvent.

The term “hydrocarbyl” refers to a monovalent moiety formed by removing a hydrogen atom from a hydrocarbon. The term “hydrocarbyl” includes alkyl groups, alkenyl groups, and alkynyl groups. A preferred “hydrocarbyl” group is an “alkyl” group. Representative hydrocarbyl groups are alkyl groups having 1 to 25 carbon atoms, such as methyl, ethyl, propyl, butyl, pentyl, hexyl, heptyl, octyl, nonyl, undecyl, decyl, dodecyl, octadecyl, nonadecyl, eicosyl, heneicosyl, docosyl, and tricosyl, and the isomeric forms thereof such as iso-propyl, t-butyl, iso-butyl, sec-butyl, 1,1-dimethylpropyl, 1,2-dimethylpropyl, 2,2-dimethylpropyl, 1-ethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, and 3,3-dimethyl-butyl; alkenyl groups having 2 to 25 carbon atoms, such as methenyl, ethenyl, 1-propenyl, 2-propenyl, iso-propenyl, 1-butenyl, 2-butenyl, 3-butenyl, iso-butenyl, sec-butenyl, 1-pentenyl, 2-pentenyl, 3-pentenyl, 4-pentenyl, hexenyl, heptenyl, octenyl and the isomeric forms thereof; alkynyl groups having 2 to 25 carbon atoms, such as ethynyl, 1-propynyl, 2-propynyl, 1-butynyl, 2-butynyl, 3-butynyl, 1-pentynyl, 2-pentynyl, 3-pentynyl, 4-pentynyl, hexynyl, pentynyl, and octynyl, and the isomeric forms thereof. A hydrocarbyl group may also be substituted with a “cyclohydrocarbyl” group. Accordingly, groups such as 2-(cyclopropyl)-ethyl, cyclohexylmethyl, cyclopropylethyl, and cyclopropylmethyl, are contemplated hydrocarbyl groups.

In some embodiments, a “hydrocarbyl group” contains 1 to 6 members (C₁-C₆). In other embodiments, the hydrocarbyl radical contains 1 to 3 members (C₁-C₃). In yet other embodiments, the hydrocarbyl radical may contain from 1 to 17 substitutions, or in another embodiment from 1 to 5 substitutions. The hydrocarbyl group may also contain one or more substituents.

The term “cyclohydrocarbyl”, by itself or part of another substituent, unless otherwise stated, refers to a cyclic hydrocarbyl group which may be fully saturated, monounsaturated, or polyunsaturated and includes C₃-C₁₅ hydrocarbons in a ring system. The cyclohydrocarbyl group may contain one or more substituents. In one embodiment, the ring contains 3 to 6 members (C₃-C₆).

In another embodiment, a cyclohydrocarbyl group may have from 1 to 11 substitutions, or in another embodiment from 2 to 6 substitutions. Examples of cyclohydrocarbyl groups include, but are not limited to cyclopropyl, cyclopentyl, cyclohexyl, cyclohex-1-enyl, cyclohex-3-enyl, cycloheptyl, cyclooctyl, norbornyl, decalinyl, adamant-1-yl, adamant-2-yl, bicyclo[2.1.0]pentyl, bicyclo[3.1.0]-hexyl, spiro[2.4]heptyl, spiro[2.5]octyl, bicyclo-[5.1.0]octyl, spiro[2.6]nonyl, bicyclo[2.2.0]hexyl, spiro[3.3]heptyl, bicyclo[4.2.0]octyl, and spiro[3.5]nonyl, and the like.

The term “alkyl”, by itself or as part of another substituent, unless otherwise stated, refers to a straight chain or branched chain, or cyclic hydrocarbon radical, or combination thereof, which may be fully saturated, monounsaturated or polyunsaturated and can include divalent and multivalent radicals, having the number of not more than 15 of carbon atoms. Examples of saturated hydrocarbon radicals include, but are not limited to groups such as methyl, ethyl, n-propyl, isopropyl, n-butyl, t-butyl, isobutyl, sec-butyl, cyclopropyl, pentyl, hexyl, heptyl, octyl, nonyl, decyl, undecyl, and dodecyl, 2-(cyclopropyl)ethyl, cyclohexylmethyl, cyclopropylethyl, cyclohexyl, cyclopropylmethyl, 1-methylbutyl, 2-methylbutyl, 3-methylbutyl, 1,1-dimethylpropyl, 1,2-dimethylpropyl, 2,2-dimethylpropyl, 1-ethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, ethylmethylpropyl, trimethylpropyl, methylhexyl, dimethylpentyl, ethylpentyl, ethylmethylbutyl, dimethylbutyl, spiropentyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to vinyl, prop-2-enyl, crotyl, isopent-2-enyl, butadien-2-yl, penta-2,4-dienyl, penta-1,4-dien-3-yl, ethynyl, prop-1-ynyl, prop-3-ynyl, but-3-ynyl, and the higher homologs and isomers, and the like.

The term “heteroalkyl”, by itself or as part of another substituent, unless otherwise stated, refers to a straight or branched chain, or cyclic hydrocarbon radical, or combinations thereof, consisting of one to fourteen carbon atoms and from one to six heteroatoms selected from oxygen, nitrogen, sulfur, and silicon, and where the nitrogen, sulfur and silicon atoms may optionally be oxidized and the nitrogen atom may optionally be quaternized. The heteroatoms O, N and S may be placed at any interior position of the heteroalkyl group. The heteroatom Si may be placed at any position of the heteroalkyl group, including the position at which the heteroalkyl group is attached to the remainder of the molecule. Examples include, but are not limited to 2-methoxyethyl, 2-(methylamino)ethyl, 2-(dimethylamino)ethyl, 2-(ethylthio)methyl, 2-(methylsulfinyl)ethyl, 2-(methylsulfonyl)ethyl, 2-methoxyvinyl, trimethylsilyl, dimethyl(vinyl)silyl, 2-(cyclopropylthio)ethyl, and 2-(methoxyimino)ethyl. Up to two heteroatoms may be consecutive, such as, for example, (methoxyamino)methyl and trimethylsilyloxy.

The terms “cycloalkyl” and “heterocycloalkyl”, by themselves or as part of another substituent, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to cyclopropyl, cyclopentyl, cyclohexyl, cyclohex-1-enyl, cyclohex-3-enyl, cycloheptyl, cyclooctyl, norbornyl, decalinyl, adamant¬-1-yl, adamant-2-yl, bicyclo[2.1.0]pentyl, bicyclo[3.1.0]hexyl, spiro[2.4]heptyl, spiro[2.5]octyl, bicyclo[5.1.0]octyl, spiro[2.6]nonyl, bicyclo[2.2.0]hexyl, spiro[3.3]heptyl, bicyclo[4.2.0]octyl, and spiro[3.5]nonyl, and the like. Examples of heterocycloalkyl include, but are not limited to piperidinyl, piperidin-2-yl, piperidin-3-yl, morpholin-4-yl, morpholin-3-yl, tetrahydrofuran-2-yl, tetrahydrofuran-3-yl, tetrahydrothien-2-yl, tetrahydrothien-3-yl, piperazinyl, piperazin-2-yl, and the like.

The terms “alkoxy” refers to those groups attached to the remainder of the molecule via an oxygen atom. Suitable examples of alkoxy groups include, but are not limited to methoxy, ethoxy, n-propoxy, iso-propoxy, n-butoxy, tert-butoxy, pentoxy, hexoxy, heptoxy, and the like.

The term “aryl”, unless otherwise stated, refers to a polyunsaturated, aromatic, hydrocarbon substituent, which can be a monocyclic system or polycyclic ring system (with up to three rings) which are fused together or linked covalently. The monocyclic or polycyclic ring system comprises about 5 to about 16 carbon atoms. Suitable examples of aryl groups include, but are not limited to phenyl, naphthyl, anthracenyl, and the like.

The term “heteroaryl” refers to “aryl” groups that contain from one to four heteroatoms selected from nitrogen, oxygen, and sulfur, where the nitrogen and sulfur atoms are optionally oxidized, and one or several nitrogen atoms are optionally quaternized. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl.

The terms “arylalkyl” and “heteroarylalkyl” is meant to include those radicals in which an aryl group is attached to an alkyl group (e.g., benzyl, phenethyl, pyridylmethyl, and the like) including those alkyl groups in which a carbon atom (e.g., a methylene group) has been replaced by, for example, an oxygen atom (e.g., phenoxymethyl, pyrid-2-yloxymethyl, 3-(naphth-1-yloxy)propyl, and the like).

Each of the above terms “alkyl”, “heteroalkyl”, “cycloalkyl”, “heterocycloalkyl”, “alkoxy”, “aryl”, “heteroaryl”, “arylalkyl”, and “heteroarylalkyl” are meant to include optionally substituted forms of the indicated radical.

As used herein “optionally substituted” refers to a substitution of a hydrogen atom, which would otherwise be present for the substituent. When discussing ring systems, the optional substitution is typically with 1, 2, or 3 substituents replacing the normally-present hydrogen. When referencing straight and branched moieties, however, the number of substitutions may be more, occurring wherever hydrogen is present. The substitutions may be the same or different.

Illustrative substituents, which with multiple substituents can be the same or different, include halogen, haloalkyl, R′, OR′, OH, SH, SR′, NO₂, CN, C(O)R′, C(O)(alkyl substituted with one or more of halogen, haloalkyl, NH₂, OH, SH, CN, and NO₂), C(O)OR′, OC(O)R′, CON(R′)₂, OC(O)N(R′)₂, NH₂, NHR′, N(R′)₂, NHCOR′, NHCOH, NHCONH₂, NHCONHR′, NHCON(R′)₂, NRCOR′, NRCOH, NHCO₂H, NHCO₂R′, NHC(S)NH₂, NHC(S)NHR′, NHC(S)N(R′)₂, CO₂R′, CO₂H, CHO, CONH₂, CONHR′, CON(R′)₂, S(O)₂H, S(O)₂R′, SO₂NH₂, S(O)H, S(O)R′, SO₂NHR′, SO₂N(R′)₂, NHS(O)₂H, NR'S(O)₂H, NHS(O)₂R′, NR'S(O)₂R′, Si(R′)₃, where each of the preceding may be linked through a divalent alkylene linker, (CH₂)ₓ, where x is 1, 2, or 3. In embodiments where a saturated carbon atom is optionally substituted with one or more substituent groups, the substituents may be the same or different and also include ═O, ═S, ═NNHR′, ═NNH₂, ═NN(R′)₂, ═N—OR′, ═N—OH, ═NNHCOR′, ═NNHCOH, ═NNHCO₂R′, ═NNHCO₂H, ═NNHSO₂R′, ═NNHSO₂H, ═N—CN, ═NH, or ═NR′. For each of the preceding, each may be linked through an alkylene linker, (CH₂)ₓ, where x is 1, 2, or 3, Each occurrence of R′ is the same or different and represents hydrogen, alkyl, alkenyl, alkynyl, cycloalkyl, aryl, heterocyclyl, or heteroaryl, or when two R′ are each attached to a nitrogen atom, they may form a saturated or unsaturated heterocyclic ring containing from 4 to 6 ring atoms.

The term “agriculturally acceptable salt” refers to alkali metal, ammonium, alkyl sulphonium or alkylphosphonium salt or the quaternary salt of an amine having a molecular weight of less than 300.

As used herein, the term “heteroatom” is meant to include oxygen (O), nitrogen (N), and sulfur (S).

The phrases “independently selected”, “independently” and their variants, when used in reference to two or more of the same substituent group are used herein to mean that that two or more groups can be the same or different.

As used herein, a continuously flowing process is a chemical reaction or series of chemical reactions that run in a continuously flowing stream. Typically, pumps move fluids comprising reaction components into a tube, and where tubes join together, the fluids come into contact with each other and the desired reaction takes place. In some embodiments, the term “continuously flowing process” refers to any process exemplified herein that at least removes most of the solvent or solvent alcohol by product in a reaction step involving mixing with a boron containing reagent that is immediately followed by a second step that involves reaction with an organometallic reagent between the temperatures of −80° C. and 10° C. In some embodiments, the term “continuously flowing process” refers to any process exemplified here than involves a reaction with an organometallic reagent. In some embodiments, the term “continuously flowing process” refers to any process exemplified here than involves a reaction with an organometallic reagent that occurs between −80° C. and 10° C. In some embodiments, the term “continuously flowing process” refers to any process exemplified here than involves a reaction with an organometallic reagent that occurs between −40° C. and 10° C. In some embodiments, the term “continuously flowing process” refers to any process exemplified here than involves a reaction with an organometallic reagent that occurs between −30° C. and 10° C. In some embodiments, the term “continuously flowing process” refers to any process exemplified here than involves a reaction with an organometallic reagent that occurs between 10° C. and 80° C. In some instances, the continuously flowing process also refers to any process described herein that does not involve directly isolating the intermediate acyclic boronic acid ester. In yet other instances, the continuously flowing process refers to any process where toluene is mixed in with the boron containing reagent to form the boronic acid ester continuously.

In other instances, the continuously flowing process refers to any process described herein that involves contacting a first reaction stream comprising a compound of formula I or a compound of formula Ia with a second reaction stream comprising an organolithium reagent, an organomagnesium reagent, or magnesium. In some embodiments the first reaction stream and the second reaction stream further comprise a solvent. For example, in some embodiments, the first reaction stream further comprises THF and the second reaction stream further comprises hexane.

The compound of formula III can be treated with a boron-containing reagent to produce a compound of formula (I). The boron containing reagent can be, for example, trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, or 2-ethoxy-4,4,5,5-tetramethyl-1,3,2-dioxaborolane. The reaction generally progresses via formation of the corresponding boronic acid ester.

The continuously flowing process as used herein, provides unexpected advantages because Applicants have surprisingly found that reactions in the continuously flowing process are completed in substantially shorter time than a standard standalone reaction. In some cases, the reaction is completed in a matter of seconds as opposed to minutes or hours. Another advantage is that substantially milder reaction conditions can be employed. Allowing the reaction to occur at a higher temperature has the further advantage of being energy efficient and less costly than effecting the reaction at lower temperatures. In addition, reactions in a continuously flowing process are easy to scale up because traditional steps, such as, isolation and purification of intermediate stage compounds can be substantially or completed eliminated.

The present disclosure also provides general processes for preparing benzoxaboroles, compositions of acyclic alkoxy boronic acid esters as intermediates, and processes of mixing the intermediates with organomagnesium, magnesium or organolithium reagents to form the desired benzoxaboroles.

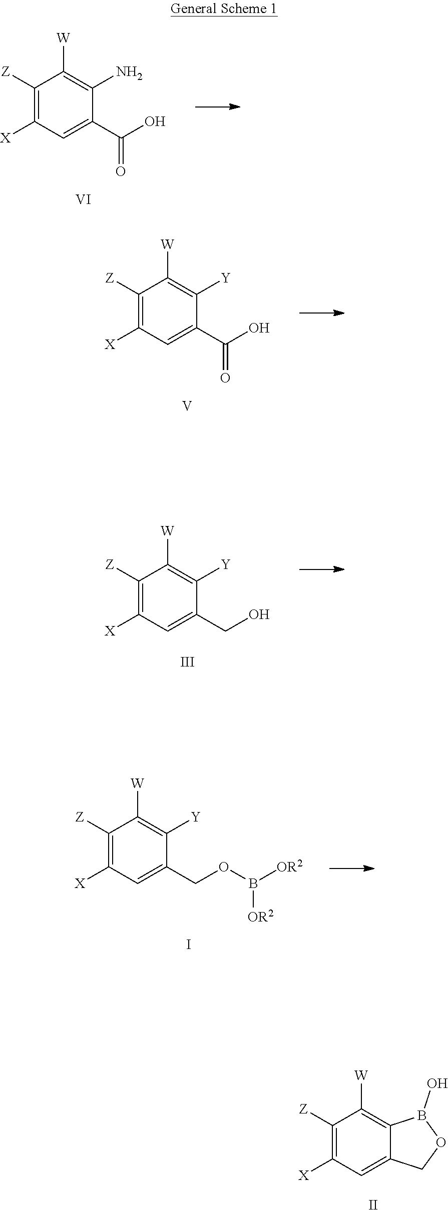

As shown in general scheme 1, a compound of formula VI can be treated with a nitrite source, an acid, a catalyst, and a halide source to produce a compound of formula V. The nitrite source can be, for example, alkyl nitrite, t-butyl nitrite, ethyl nitrite, amyl nitrite, polyethylene glycol nitrite, sodium nitrite, potassium nitrite, or cesium nitrite. The acid can be for example, hydrobromic acid. The catalyst can be, for example, a copper catalyst, a copper⁻¹ ion, or a copper⁻² ion, CuSO₄, CuBr or copper metal. The halide source can be, for example, Br₂, TMSBr, hydrobromic acid, iodine (I₂), TMSI, hydroiodic acid, iodine monochloride, mixtures of free iodine and free chloride, alkali iodides, alkali halides such as sodium bromide or potassium bromide, earth alkali bromides such as magnesium bromide or calcium bromide, metal halides, inorganic iodides, or transition metal halides such as cuprous bromide. The reaction generally progresses via formation of the corresponding diazo compound followed by a reaction to form the corresponding aryl halide compound.

The compound of formula V can then be treated with a reducing agent to produce a compound of formula III. The reducing agent can be, for example, borane complex, borane-tetrahydrofuran, borane-dimethylsulfide, lithium aluminum hydride, or sodium borohydride.

The reaction generally progresses via reduction of the carboxylic acid functional group to the corresponding alcohol.

The compound of formula III can be treated with a boron containing reagent to produce a compound of formula (I). The boron containing reagent can be, for example, trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, or 2-ethoxy-4,4,5,5-tetramethyl-1,3,2-dioxaborolane. The reaction generally progresses via formation of the corresponding boronic acid ester.

The compound of formula (I) can be treated with an organomagnesium or organolithium reagent to produce a compound of formula (II) in a continuously flowing process. The organomagnesium or organolithium reagent can be, for example, isopropyl magnesium chloride, isopropylmagnesium chloride lithium chloride complex, n-butyllithium, sec-butyllithium, or tert-butyllithium.

### EXAMPLES

The present disclosure will now be further described by way of the following non-limiting examples. In applying the disclosure of the examples, it should be kept clearly in mind that other and different embodiments of the synthetic methods disclosed according to the present disclosure will no doubt suggest themselves to those of skill in the relevant art.

In the foregoing and in the following examples, all temperatures are set forth uncorrected in degrees Celsius.

### Example 1: Exemplary Synthesis of 5-chlorobenzo[c][1,2]oxaborol-1(3H)-ol (low-yield/no crystalline product)

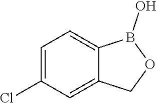 [SMILES: OB1OCc2cc(Cl)ccc21]

(2-bromo-5-chlorophenyl)methanol (1.00 g, 4.54 mmol) and B(i-PrO)₃ (1.71 g, 9.09 mmol) in toluene (7 mL) were stirred for 2 h at 120° C., all the solvent and by-product isopropyl alcohol were removed. The resulting solid was dissolved in THF (18 mL) under N₂ atmosphere, then cooled to −78° C., and n-BuLi (2.5 M, 2.0 mL) was added to the solution dropwise. The solution was warmed to room temperature and stirred for 2 h. The solution was cooled to 0° C. and adjusted to pH=1 with 2M HCl and extracted with EA. The combined organic layer was washed with saturated NaCl solution, dried with Na₂SO₄ and concentrated to give the crude benzoxaborole 0.4 g, crystallization of the crude product failed.

The crude product was analyzed by HPLC, and the conversion of this reaction was 41.5%, with 24.7% of the starting material remaining. Percent yield was calculated to be about 35%. 1H-NMR (400 MHz, DMSO-d6) δ (ppm): 9.27 (s, 1H) 7.70 (d, J=8.0 Hz, 1H) 7.48 (s, 1H) 7.37 (d, J=8.0 Hz, 1H) 4.95 (s, 2H). HPLC conditions: C₁₈ column, buffer A is 20% acetonitrile in water +0.1% TFA, buffer B is 80% acetonitrile in water +0.1% TFA, under a 5 min gradient from 10% B to 90% B.

### Example 2: 2-bromo-5-chlorobenzyl diisopropyl borate

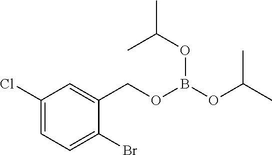 [SMILES: CC(C)OB(OCc1cc(Cl)ccc1Br)OC(C)C]

(2-bromo-5-chlorophenyl)methanol (80.0 g, 361 mmol) and B(i-PrO)₃ (91.7 g, 487 mmol) in toluene (560 mL) were stirred for 1 h at 120° C. TLC (Petroleum ether/Ethylacetate=3/1) showed the appearance of a new spot. Then toluene and isopropyl alcohol mixture were removed from the reaction mixture under reduced pressure, resulting in 126.23 g of crude product, which was used in the next step without further purification. The alkoxy boronic acid ester obtained as brown oil was confirmed by ¹HNMR. ¹HNMR (400 MHz, DMSO-d6) δ (ppm): 7.54-7.65 (m, 1 H), 7.43 (t, J=3.42 Hz, 1H), 7.29 (d, J=8.60 Hz, 1H), 4.76-4.93 (m, 2H), 4.22-4.51 (m, 2H), 1.11 (d, J=6.1 Hz, 12H).

### Example 3: Synthesis of (2-bromo-5-chlorophenyl)methanol

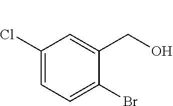

To a solution of 2-amino-5-chlorobenzoic acid (50.0 g, 291 mmol) in H₂SO₄ (175 mL) and H₂O (300 mL) was added NaNO₂ (30.2 g, 1.50 eq, in 45 mL H₂O) dropwise at 0° C. (A evolution of red gas sets in during this period). The mixture was stirred at 0° C. for 0.5 hr. Then the mixture was added to a solution of CuBr (83.6 g, 583 mmol, 17.8 mL, 2.00 eq) in HBr (118 g, 583 mmol, 40.0% purity, 2.00 eq) at 0° C. within 0.5 hr. The mixture was stirred at 90° C. for 11 hrs. TLC (Petroleum ether:Ethyl acetate=2:1, product Rf=0.43) showed the reaction was completed. The reaction was cooled to 25° C., and then 500 mL H₂O was added dropwise to the reaction mixture at 25° C. over a period of 0.5 hr. During the period, a white solid precipitated out. The resulting suspension was stirred at 25° C. for 2 hrs and filtered. The filter cake was dissolved in EtOAc (150 mL), and the solution was washed with Na₂S₂O₃ (1.00 M, 50.0 mL×1), brine (50.0 mL×1), dried over Na₂SO₄, filtered and concentrated under reduced pressure to give the 2-bromo-5-chlorobenzoic acid (60.0 g, 255 mmol, 87.4% yield) as a yellow solid. ¹H-NMR (400 MHz, DMSO-d₆) δ (ppm): 13.72 (s, 1H), 7.76-7.78 (m, 1H), 7.72-7.75 (m, 1H), 7.50-7.52 (m, 1H).

To a solution of 2-bromo-5-chlorobenzoic acid (30.0 g, 127 mmol) in THF (90.0 mL) was added BH₃/Me₂S (10.0 M, 19.1 mL, 1.50 eq) at 0° C. The mixture was stirred at 25° C. for 12 hrs. TLC (Petroleum ether:Ethyl acetate=3:1, Rf=0.43) showed the reaction was completed. The reaction mixture was cooled to 0° C. and MeOH (75.0 mL) was added dropwise to decompose excess BH₃. The resulting mixture was stirred until no bubbles were released and then 10% NaOH (60.0 mL) was added at 0° C. Then the mixture was stirred at 25° C. for 12 hrs. The mixture was mixed with H₂O (100 mL) and extracted with EtOAc (50.0 mL×1, 25.0 mL×1). The combined organic layers were washed with brine (50.0 mL×1), dried over Na₂SO₄, filtered and concentrated under reduced pressure to give compound (2-bromo-5-chlorophenyl)methanol (24.0 g, 106 mmol, 83.0% yield) as a yellow solid. ¹HNMR (400 MHz, DMSO-d₆) δ (ppm): 7.59 (d, J=8.4 Hz, 1H), 7.52 (d, J=2.7 Hz, 1H), 7.27 (dd, J=2.6, 8.5 Hz, 1H), 5.59 (t, J=5.7 Hz, 1H), 4.49 (d, J=5.7 Hz, 2H).

### Example 4: Continuous Flow Reaction for Synthesis of 5-chlorobenzo[c][1,2]oxaborol-1(3H)-ol

Feedstock A consisted of 2-bromo-5-chlorobenzyl diisopropyl borate dissolved in THF as a 0.3 M solution (601.98 mL, 1.0 eq) and was pumped at 4.0 mL/min.

Feedstock B consisted of commercially available 2.5 M n-BuLi (144.48 mL) in hexane and was pumped at 0.96 mL/min. In order to make sure the reactants were sufficiently cooled before mixing, precooling loops were used for both Feedstock A and Feedstock B, which were cooled at −20° C. in PFA 1/8 tubing, and the loop volume was 9.4 mL and 11.3 mL, respectively. The feedstocks were maintained under an atmosphere of nitrogen, and the system pressure was maintained at 0.1 bar. The residence time for the lithiation step was set to 1.89 min at −20° C., and residence time for the borylation step was set to 2.27 min at 15° C. The collected product stream was cooled to 0° C. and adjust to pH=1 with 2M HCl. The solution was extracted with ethyl acetate (500 mL×2) and the combined organic layer was washed with saturated NaCl solution (500 mL), dried with anhydrous Na₂SO₄ and concentrated under vacuum to give the crude product. The crude product was slurried in heptane (160 mL, 2V) for 5 h to give desired product as white solid (23.0 g, 98.9% purity, yield 75%), which was confirmed by HPLC, LCMS, and ¹HNMR. ¹H NMR (400 MHz, DMSO-d₆) δ (ppm): 9.30 (s, 1H), 7.72 (d, J=8.0 Hz, 1H), 7.51 (s, 1H), 7.40 (d, J=8.0 Hz, 1H), 4.98 (s, 2H).

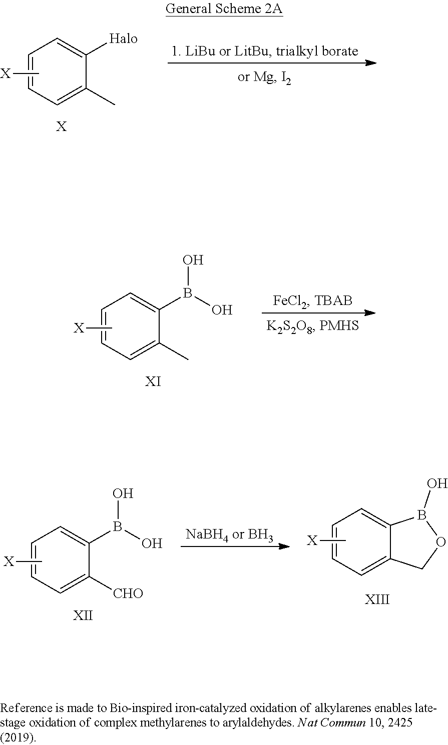

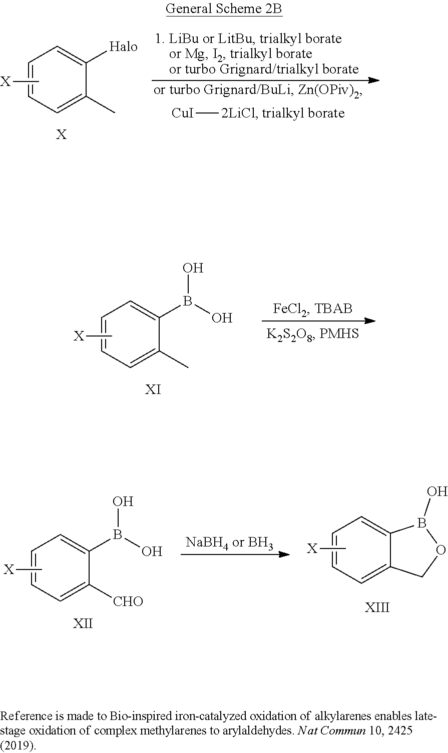

An alternate synthetic method may be used in the flow method of the present disclosure. As shown in General Scheme 2A and General Scheme 2B, a alkylarene of formula (X) may be treated with an organolithium, magnesium, or organomagnesium compound as noted herein. Reference is made to Bio-inspired iron-catalyzed oxidation of alkylarenes enables late-stage oxidation of complex methylarenes to arylaldehydes. Nat Commun 10, 2425 (2019) and ChemCatChem 10.1002/cct.201800939. Thereafter, the resulting compound of formula (XI) may be treated to an iron-catalyzed oxidation to form aldehyde derivative, a compound of formula (XII). A compound of formula (XII) may be treated with a reducing agent to form a compound of formula (XIII). A compound of formula (XIII) may correlate to compounds of formula (II). Thus, one embodiment of the present disclosure includes mixing a compound of formula (X)

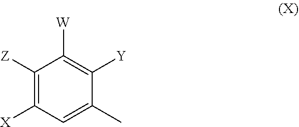

with an organomagnesium, magnesium, or an organolithium reagent to produce a compound of formula (XI)

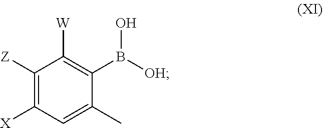

treating a compound of formula (XI) to an iron-catalyzed oxidation to form an aldehyde derivative of formula (XII)

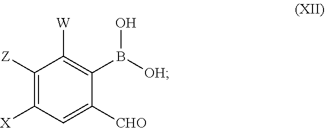

and treating a compound of formula (XII) with a reducing agent to form a compound of formula (II) or an agriculturally or pharmaceutically acceptable salt thereof:

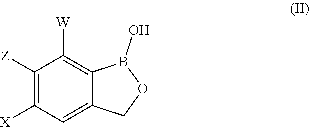

where:
X is hydrogen, fluorine, chlorine, bromine, or

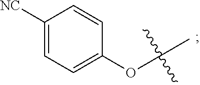 [SMILES: *Oc1ccc(C#N)cc1]

Z and W is each independently hydrogen, or OR³ where R³ is a C₁-C₅ hydrocarbyl; and
Y is bromine or iodine. As shown, the substituent patterns of formulae (X), (XI), and (XII) correlate to the present disclosure. Reference is made to each of Hu et al. Bio-inspired iron-catalyzed oxidation of alkylarenes enables late-stage oxidation of complex methylarenes to arylaldehydes. Nat Commun 10, 2425 (2019), and Usutani et al., Development and Scale-up of a Flow Chemistry Lithiation-Borylation Route to a Key Boronic Acid Starting Material, Org. Process Res. Dev., 21, pp. 669-673, 2017, each incorporated by reference with regard to such background teaching therein.

### Prophetic Example A: Synthesis of 5-chlorobenzo[c][1,2]oxaborol-1(3H)-ol

Methods for synthesizing 5-chlorobenzo[c][1,2]oxaborol-1(3H)-ol includes using a modified procedure as shown in Prophetic Scheme A below:

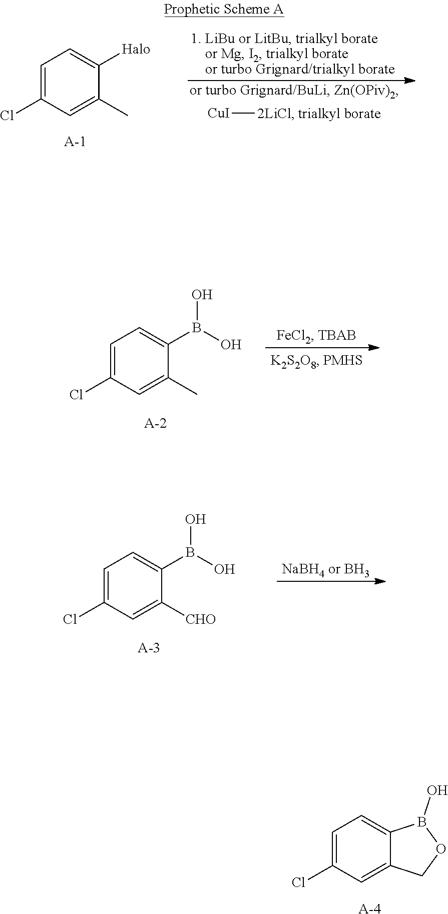

First, compound A-1 is converted to the corresponding boronic acid compound A-2 using a modified flow chemistry process described in Org. Process Res. Dev. 2017, 21, 669-673. As one example, Feedstock A is prepared by dissolving compound A-1 in THF. Feedstock B contains n-BuLi or t-BuLi, and Feedstock C is prepared by dissolving a trialkyl borate, such as B(OiPr)₃, in THF. Feedstocks A, B, and C are kept under nitrogen and pre-cooling loops can be used for temperature control. The lithiation step is performed first, followed by the borylation step, where each step is allowed to occur for the appropriate residence time. The collected product stream is subjected to aqueous work-up and compound A-2 is isolated.

Alternatively, compound A-2 is prepared from compound A-1 using the same reagents described above but where the reaction is modified to be a batch process.

In another example for the conversion of A-1 to A-2, Mg and 12, or a Grignard exchange reaction, or reaction via an organozinc intermediate as shown in Prophetic Scheme A are used in place of the organolithium reagent described above. These reactions can be performed via a batch process or a flow process. Reference is made to Fu et al., Copper-Catalyzed Monoorganylation of Trialkyl Borates with Functionalized Organozinc Pivalates, ChemCatChem 10, 2018, https://doi.org/10.1002/cctc.201800939 and the flow chemistry examples and references described therein.

Next, A-2 is converted to aldehyde A-3 using a modified procedure described in Hu, P., et al. Bio-inspired iron-catalyzed oxidation of alkylarenes enables late-stage oxidation of complex methylarenes to arylaldehydes. Nat Commun 10, 2425 (2019). For example, compound A-2 is mixed with FeCl₂, K₂S₂O₈, TBAB, MeCN, H₂O, and PMHS in a flask. This reaction mixture is then stirred at about 80° C. Reaction progress is monitored by TLC. The reaction is then cooled to room temperature and subjected to aqueous work up conditions to afford product A-3.

Finally, the target compound A-4 is prepared by reduction, for example, with NaBH₄ or BH₃.

While aspects of the present disclosure have been particularly shown and described with reference to the embodiments above, it will be understood by those skilled in the art that various additional embodiments may be contemplated by the modification of the disclosed compounds, materials, and methods without departing from the spirit and scope of what is disclosed. Such embodiments should be understood to fall within the scope of the present disclosure as determined based upon the claims and any equivalents thereof.

1-23. (canceled)

24. A process comprising:
mixing a compound of formula (I): 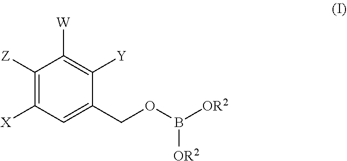
with an organomagnesium, magnesium, or an organolithium reagent to produce a compound of formula (II) or an agriculturally or pharmaceutically acceptable salt thereof: 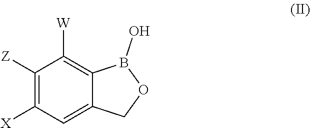
where:
X is hydrogen, fluorine, chlorine, bromine, or 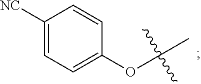 [SMILES: *Oc1ccc(C#N)cc1]
Z and W is each independently hydrogen, or OR³ where R³ is a C₁-C₅ hydrocarbyl;
Y is bromine or iodine; and
R² is selected from the group consisting of: isopropyl, methyl, ethyl, n-propyl, sec-butyl, tert-butyl, and n-butyl, or two R² groups taken together with the boron atom form a ring.

25. A continuously flowing process comprising:
mixing a compound of formula (X) 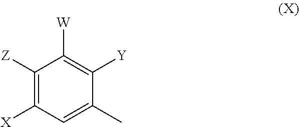
with an organomagnesium, magnesium, or an organolithium reagent and a boron containing reagent to produce a compound of formula (XI) 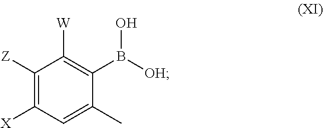
treating a compound of formula (XI) to an iron-catalyzed oxidation to form an aldehyde derivative of formula (XII): 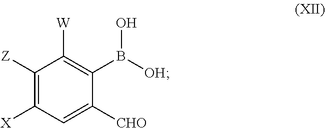
treating a compound of formula (XII) with a reducing agent to form a compound of formula (II) or an agriculturally or pharmaceutically acceptable salt thereof: 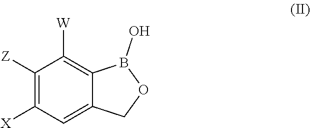
where:
X is hydrogen, fluorine, chlorine, bromine, or 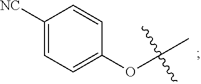 [SMILES: *Oc1ccc(C#N)cc1]
Z and W is each independently hydrogen, or OR³ where R³ is a C₁-C₅ hydrocarbyl; and
Y is bromine or iodine.

26. The continuously flowing process of claim 25, wherein Z and W are hydrogen, and wherein the boron containing reagent is a trialkyl borate and the reducing agent is NaBH₄ or BH₃.

27. (canceled)

28. A compound of formula (I): 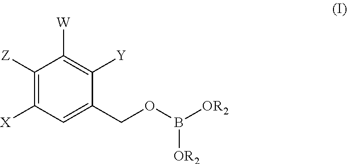
wherein:
X is hydrogen, chlorine, bromine, or 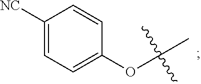 [SMILES: *Oc1ccc(C#N)cc1]
Z and W is each independently hydrogen, or OR₃ wherein R₃ is a C₁-C₅ hydrocarbyl;
Y is bromine or iodine; and
R² is selected from the group consisting of: isopropyl, methyl, ethyl, n-propyl, sec-butyl, tert-butyl, and n-butyl, or two R² groups taken together with the boron atom to form a ring.

29. (canceled)

30. The compound of claim 28: 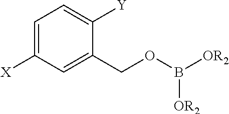
wherein:
X is chlorine; Y is bromine; Z and W are each hydrogen; and R² is isopropyl.

31. The process of claim 24, wherein the process is a continuously flowing process.

32. The process of claim 24, wherein Z and W are both hydrogen.

33. The process of claim 24, wherein X is chlorine and Y is bromine.

34. The process of claim 24, further comprising a step of slurrying the compound of formula (II) in a hydrocarbon solvent, wherein the hydrocarbon solvent is pentane, hexane, heptane, C₅-C₁₀ hydrocarbon mixtures, or any combination thereof.

35. The process of claim 24, further comprising, preparing the compound of formula (I) by mixing a compound of formula (III): 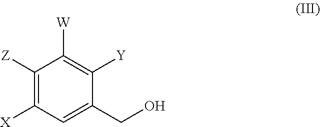
with a boron containing reagent selected from the group consisting of trimethyl borate, borane, boroxine, triethyl borate, tri-n-propyl borate, tri-isopropyl borate, tri-isobutyl borate, tri-sec-butyl borate, tri-tert-butyl borate, tri-n-butyl borate, 2-ethoxy-4,4,5,5-tetramethyl-1,3,2-dioxaborolane, and a compound of formula (IV): 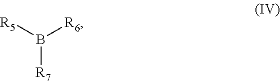
wherein each of R⁵, R⁶, and R⁷ is independently OR* or H wherein R* is C₁-C₇ alkyl, or wherein any two R* of R⁵, R⁶, and R⁷ are taken together form a ring; and
removing at least a portion of an alcohol by-product.

36. The process of claim 35 further comprising, dissolving the compound of formula (III) in a solvent, wherein the solvent is toluene, xylene, benzene, chloroform, 1,4-dioxane, tert-butyl methyl ether, 2-methyltetrahydrofuran or tetrahydrofuran.

37. The process of claim 36, wherein the solvent is toluene or THF and the boron containing reagent is tri-isopropyl borate.

38. The process of claim 24, further comprising mixing an aqueous Bronsted acid to produce the compound of formula (II), wherein the aqueous Bronsted acid comprises hydrobromic acid, phosphinic acid, hydrochloric acid, sulphuric acid, tetrafluoroboric acid, acetic acid, trifluoroacetic acid, methanesulfonic acid, or salicylic acid; and crystallizing the compound of formula (II) in presence of at least one organic solvent, wherein the at least one organic solvent is a mixture of isopropyl acetate and ethyl acetate and the acid is hydrochloric acid.

39. The process of claim 35, further comprising, preparing the compound of formula (III) by mixing a compound of formula (V): 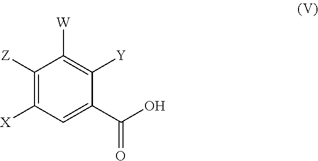
with a reducing agent, wherein each of X, Y, Z, and W is as defined; and wherein the reducing agent is a borane complex, borane-tetrahydrofuran, borane-dimethylsulfide, lithium aluminum hydride, or sodium borohydride.

40. The process of claim 39 further comprising, preparing the compound of formula (V) by mixing a compound of formula (VI): 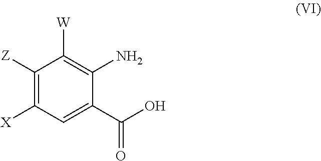
with a nitrite source, an acid, a catalyst, and a halide source, wherein each of X, Y, Z, and W is as defined; and wherein the nitrite source is an alkyl nitrite, t-butyl nitrite, ethyl nitrite, amyl nitrite, polyethylene glycol nitrite, sodium nitrite, potassium nitrite, or cesium nitrite; the halide source is Br₂, TMSBr, hydrobromic acid, iodine (I₂), TMSI, hydroiodic acid, iodine monochloride, mixtures of free iodine and free chloride, alkali iodides, alkali halides, metal halides, inorganic iodides, or transition metal halides; and the catalyst is a copper catalyst, a cuprous ion, or a cupric ion.

41. The process of claim 39, wherein the reducing agent is borane-dimethylsulfide, and wherein the boron containing reagent is tri-isopropyl borate.

42. The process of claim 24, further comprising, mixing the compound of formula (II) with HCl solution, and slurrying the compound of formula (II) in heptane prior to crystallizing.

43. The process of claim 42, wherein
the organolithium reagent is n-BuLi;
the compound of formula (I) is mixed with the organolithium reagent at a temperature between −40° C. and 10° C.; and
the compound of formula (II) is formed in a continuous flow process.

44. The process of claim 24, wherein the mixing of a compound of formula (I) and the organomagnesium, magnesium, or organolithium reagent produces a lithiation stream under a first set of parameters and a second set of parameters effects a borylation stream to produce the compound of formula (II).

45. The process of claim 24, further comprising mixing a compound of formula (III) 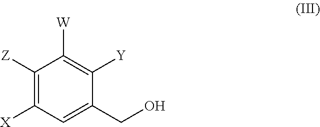
with a boron containing reagent to form the compound of formula I;
wherein the step of mixing the compound of formula 1 with an organomagnesium, magnesium, or an organolithium reagent comprises mixing the compound of formula I with n-BuLi at a temperature between about −40° C. and 10° C. to form the compound of formula II or an agriculturally or pharmaceutically acceptable salt thereof:
wherein X is chlorine; Y is bromine; Z and W are each hydrogen; and R² is selected from the group consisting of isopropyl, methyl, ethyl, n-propyl, sec-butyl, tert-butyl, and n-butyl, or two R² groups taken together with the boron atom form a ring; and
wherein the process is a one-pot process.
